(19) United States
(12) Patent Application Publication
(10) Pub. No.: US 2025/0332976 A1
(43) Pub. Date: Oct. 30, 2025

(54) ROAD CONE DEPLOYMENT AND RETRIEVAL MACHINE

(71) Applicant: FieldTorque Taranaki Limited, New Plymouth (NZ)

(72) Inventors: Nicholas Burroughs, Stratford (NZ); Alan Price, Inglewood (NZ); John Booker, Stratford (NZ)

(73) Assignee: FieldTorque Taranaki Limited, New Plymouth (NZ)

(21) Appl. No.: 18/989,347

(22) Filed: Dec. 20, 2024

(30) Foreign Application Priority Data
Apr. 30, 2024 (NZ) 810568

(51) Int. Cl. B60P 1/02; B65G 57/16; B65G 59/10

(52) U.S. Cl. CPC B60P 1/022; B65G 57/165; B65G 59/107

(57) ABSTRACT

A road cone deployment and collection system comprising including a chute having an upper road cone holding section and a rear opening at the bottom of the chute for road cone deployment and a front opening at the bottom of the chute for road cone collection. A road cone retention and release mechanism is configured to hold a stack of road cones, separate and release one road cone at a time from the stack to the chute for deployment from the rear opening, and add a road cone to a stack of road cones collected from the front opening of the chute and raised to be added to a stack of road cones.

### CROSS-REFERENCE TO RELATED APPLICATIONS

This application claims the benefit of and priority under 35 U.S.C. § 119 to NZ Application No. 810568, filed on Apr. 30, 2024, which is incorporated herein by reference in its entirety for all purposes.

### FIELD

This invention relates to a road cone deployment and retrieval system, components thereof and methods of operation.

### BACKGROUND

A range of solutions are available for the deployment and collection of road cones. Traditionally road cones have been manually placed and collected. This can be slow and inconsistent, expensive and has associated health and safety risks and costs. Fully robotic systems using a robotic arm or the like are complex and very expensive. A range of automated systems have been developed allowing road cone deployment from a vehicle and recovery to a vehicle. Such systems have issues with road cone separation, collection of road cones when a vehicle travels in a forward direction, complexity and the need for reconfiguration between deployment and recovery modes.

It is an object of the invention to provide an improved road cone deployment and retrieval system, components thereof and methods of operation or to at least provide the public with a useful choice.

### SUMMARY

According to one example embodiment there is provided a road cone deployment and collection system comprising:
a. a chute having an upper road cone holding section and a rear opening at the bottom of the chute for road cone deployment and a front opening at the bottom of the chute for road cone collection; and
b. a road cone retention and release mechanism configured to:
i. hold a stack of road cones;
ii. separate and release one road cone at a time from the stack to the chute for deployment from the rear opening; and
iii. add a road cone to a stack of road cones collected from the front opening of the chute and raised to be added to a stack of road cones.

According to one example embodiment there is provided a road cone deployment mechanism for selectively releasing a road cone from a stack of road cones including a road cone separation mechanism configured to separate the bases of adjacent road cones from each other.

According to one example embodiment there is provided a method of separating a road cone from a stack of road cones comprising rotating an element of varying radial dimension between the bases of adjacent road cones so as to separate the bases of the road cones as the radial dimension increases.

According to one example embodiment there is provided a method of simultaneous collection and deployment of road cones comprising:
a. collecting a road cone at a front opening of a chute and raising it to a stack of road cones in the chute; and
b. releasing a road cone from the stack of road cones to exit via a rear opening in the chute.

According to one example embodiment there is provided a road cone retention and release mechanism including a claw and retention member configured to move into a chute between:
a. a first configuration in which each claw and retention member do not obstruct the chute;
b. a second configuration in which each retention member supports any road cones in the chute; and
c. a third configuration in which each claw is rotated to a position between any adjacent road cones in the chute to retain the upper road cone and release the lower road cone.

Embodiments may be implemented according to any one of the dependent claims.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 shows a perspective view of a truck equipped with two road cone deployment and collection systems according to one example;

FIG. 2 shows a front view of the truck and road cone deployment and collection systems shown in FIG. 1;

FIG. 3 shows a plan view of the truck and road cone deployment and collection systems shown in FIG. 1;

FIG. 4 shows a side view of the truck and road cone deployment and collection systems shown in FIG. 1;

FIG. 5 shows a perspective view of the truck and road cone deployment and collection systems shown in FIG. 1 with one road cone deployment and collection system extended to one side of the truck;

FIG. 6 shows a plan view of the truck and road cone deployment and collection systems in the configuration shown in FIG. 5;

FIG. 7 shows a guide rail and pusher for the truck and road cone deployment and collection systems shown in FIG. 1;

FIG. 8 shows schematically the phases of road cone stack movement to load cones from multiple guide tracks into a chute for deployment;

FIGS. 9a to 9c show front and perspective views of a road cone deployment and collection unit of a road cone deployment and collection system shown in FIG. 1;

FIG. 10 shows a lance assembly of a road cone deployment and collection unit as shown in FIGS. 9a to 9c;

FIG. 11 shows a knock down assembly and guides of a road cone deployment and collection unit as shown in FIGS. 9a to 9c;

FIGS. 12a to c shows detailed views of three configurations of the road cone deployment and collection mechanism of the road cone deployment and collection system shown in FIG. 1;

FIG. 13a shows a first configuration of the road cone deployment and collection mechanism employed on the right side in FIG. 12a;

FIG. 13b shows a second configuration of the road cone deployment and collection mechanism employed on the right side in FIG. 12b;

FIG. 13c shows a third configuration of the road cone deployment and collection mechanism employed on the right side in FIG. 12c;

FIGS. 14a to 14d are schematic diagrams illustrating the collection of deployed road cones;

FIG. 15 is a schematic diagram illustrating phases in the loading of stacks of road cones from the road cone deployment and collection unit on to multiple guide tracks;

FIG. 16 is a perspective view of a spinner that may be used with a road cone deployment and collection system;

FIG. 17 illustrates a road cone deployment and collection mechanism employing a wedge in a first configuration; and

FIG. 18 illustrates a road cone deployment and collection mechanism employing a wedge in a second configuration.

### DETAILED DESCRIPTION

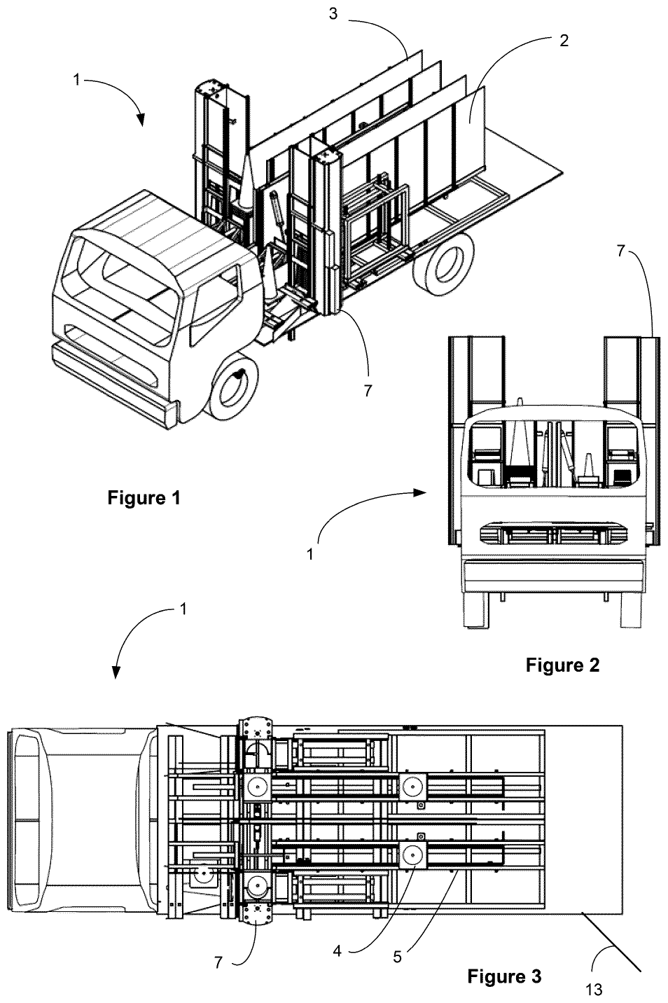

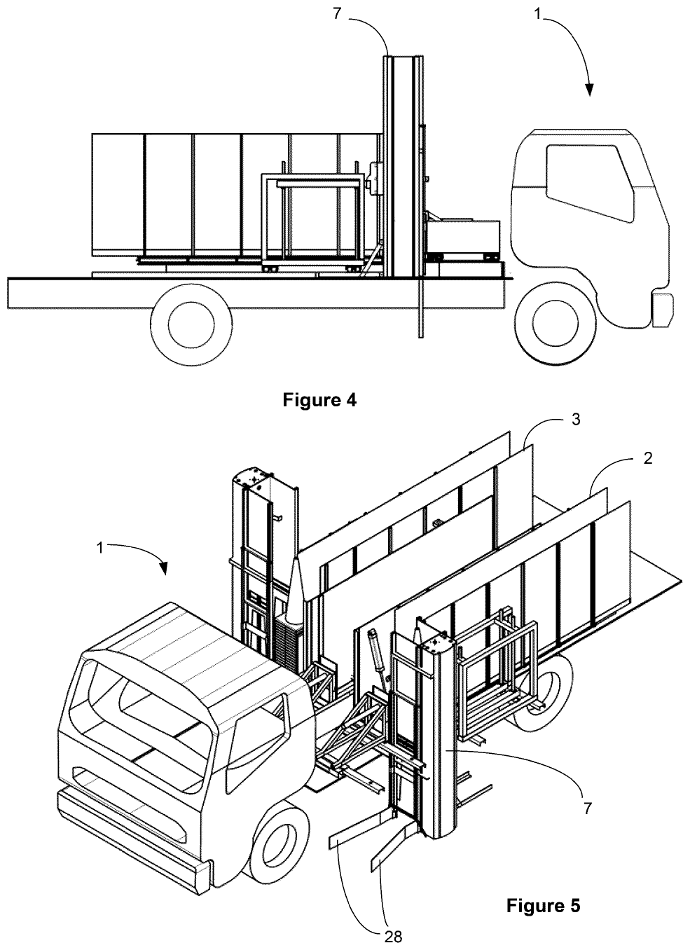

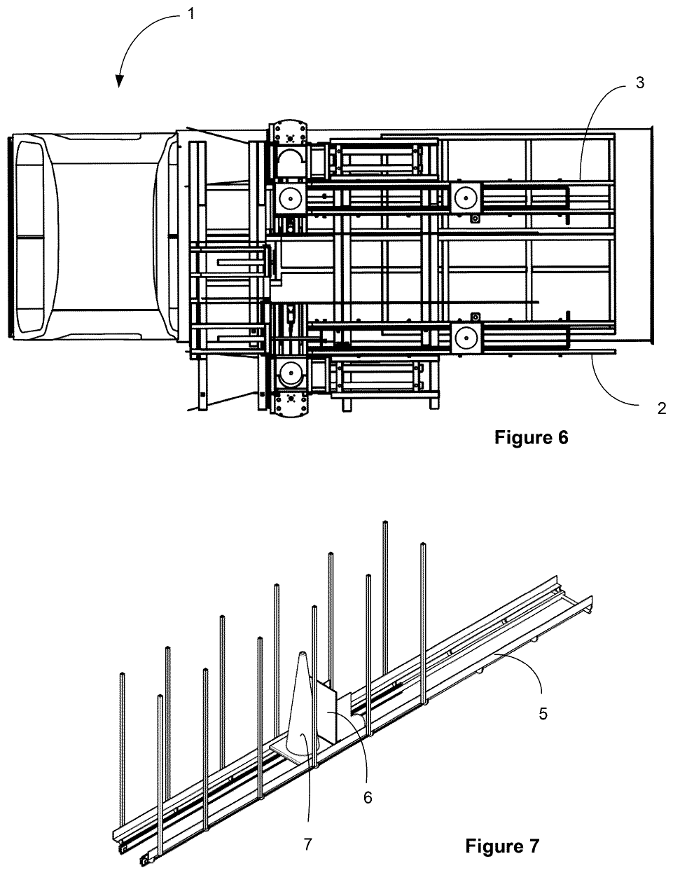

FIGS. 1 to 6 show a vehicle in the form of a truck 1 carrying two road cone deployment and collection systems 2 and 3 according to one example. Although a pair of road cone deployment and collection systems 2 and 3 are deployed in this example, to allow deployment from either side, it will be appreciated that a single system may be provided on one side only where only single side deployment or collection is required. As will be seen in FIGS. 5 and 6 the road cone deployment and collection systems 2 and 3 can be transported in a compact retracted configuration (FIGS. 1 to 4) and moved to an extended configuration (system 2 with extended unit 7 in FIGS. 5 and 6) during cone deployment and collection so that cones may be deployed and collected outside the wheelbase of the vehicle. The road cone deployment and collection systems may also be deployed on trailers or other suitable vehicles.

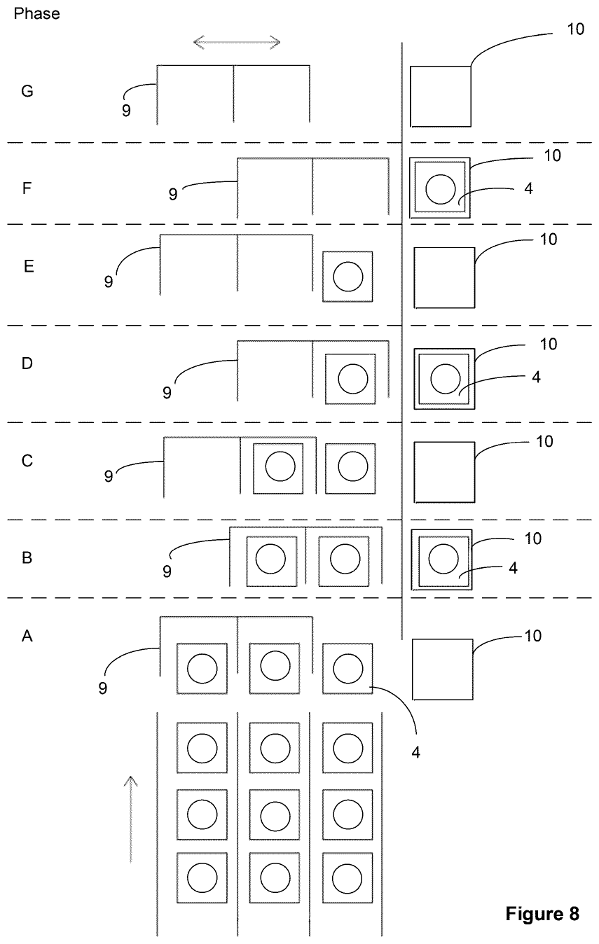

Each road cone deployment and collection system 2 and 3 has a conveyor system which moves stacks of road cones 4 to be stored on the deck of the truck 1 or deployed. In a typical application the deck may have a capacity of 360 road cones in 20 stacks. In this example road cone deployment and collection system 2 has a single guide track 5 with a chain driven pusher 6 for advancing a stack of cones 4 (only one shown) to road cone deployment and collection unit 7. In other examples multiple parallel guide tracks with respective pushers may be employed to deliver a greater number of stacks of road cones. FIG. 8 shows diagrammatically an example in which three parallel guide tracks 8a to 8c advance stacks of road cones 4 to road cone deployment and collection unit 7.

In FIG. 8 phase A shows all stacks of road cones in guide rails 8a to 8c as well as the front most row to be fed to chute 10 of road cone deployment and collection unit 7. The phases B to G show only the front most row (i.e. stages of the row in phase A engaged by pusher 9). Pusher 9 is used to move the front most row of road cones to the right to feed a new stack of road cones to chute 10. At phase A pusher 9 moves to the right to deliver a first stack of road cones 4 to chute 10 (only some stacks of road cones are indicated but a common symbol is used for all stacks of road cones). Pusher 9 is then withdrawn and moved to the left to the position in phase C. When a new stack is needed pusher 9 then moves to the right again to the position in phase D to deliver a further stack of road cones to chute 10. Pusher 9 is then withdrawn and moved to the left to the position in phase E. When a further stack of road cones is required pusher 9 then moves to the right again to the position in phase F to deliver a further stack of road cones to chute 10. Pusher 9 is then withdrawn and moved to the left to the position in phase G and the pushers of guide rails 8a to 8c move all remaining stacks of road cones forward to start a new cycle at phase A.

Road cone deployment and collection unit 7 can receive a stack of road cones 4 and deploy them individually in a line of road cones along a road or collect and stack road cones collected from a road into stacks to be stored on the truck deck. Road cone deployment and collection unit 7 can be raised during transport (see FIG. 1) and lowered to a position just above the ground during use (see FIG. 5).

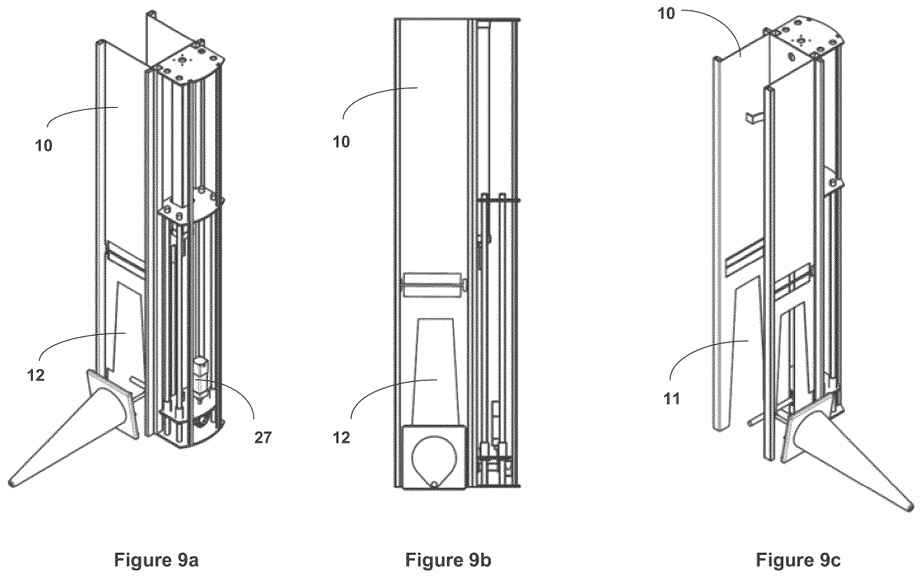

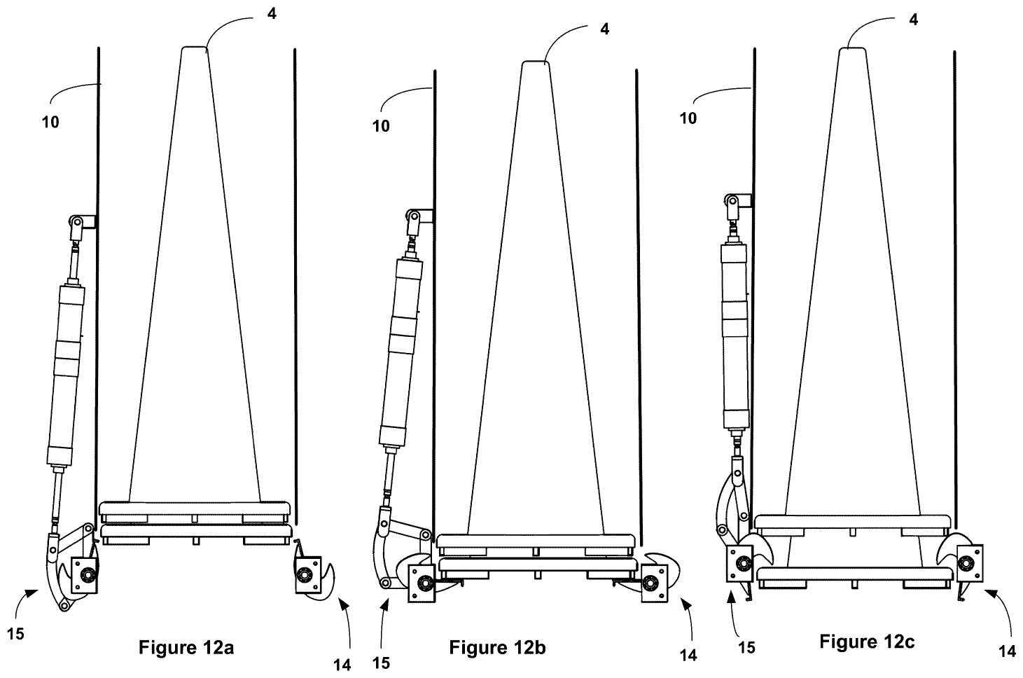

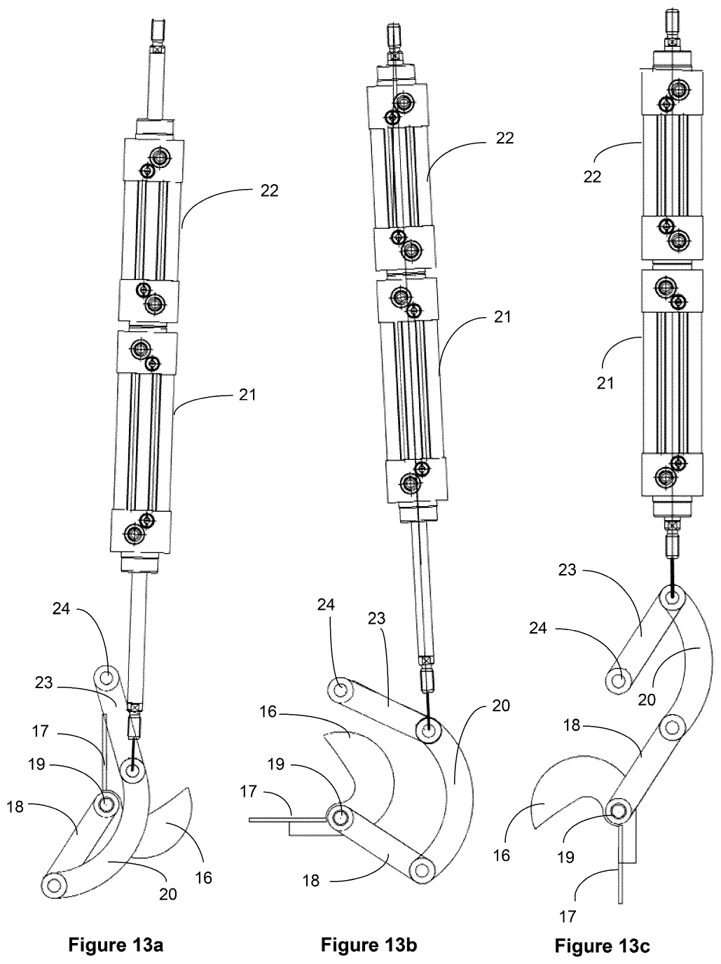

The road cone deployment and collection unit 7 is shown in more detail in FIGS. 9 to 13c and includes a chute 10 having an upper road cone holding section and a rear opening 11 at the bottom of the chute for road cone deployment and a front opening 12 at the bottom of the chute 10 for road cone collection. It also includes a road cone retention and release mechanism, which in this example includes deployment mechanisms 14 and 15 on either side (see FIGS. 12a to 12c). Deployment mechanisms 14 and 15 are the same in this embodiment but in opposed configuration. In FIGS. 12a to 12c the right side mechanism is only partially shown but it is fully shown in the detailed views in FIGS. 13 a to 13c.

Mechanism 14 will be described with reference to FIGS. 13a to 13c to describe the elements and operation of the mechanism 14 with the opposed mechanism 15 operating in the same manner in opposed configuration. A claw 16 has a retention member 17 and arm 18 that move together about a fixed pivot point 19 and are able to pass through an aperture in a side wall of chute 10. Claw 16 and retention member 17 may be integrally formed or secured together. A linkage 20 is pivotally connected to arm 18 at one end and an actuator, in the form of pneumatic cylinders 21 and 22, at the other end. A further linkage 23 is rotatable about a fixed pivot point 24 and at its other end is rotatable about a pivotable connection with linkage 20. Whilst rotation of the claw 16 and retention member 17 is achieved in this example using pneumatic cylinders 21 and 22 and a linkage it will be appreciated that a wide range of actuators may be employed and claw 16 and retention member 17 may be rotated by a rotary actuator or a range of other actuator arrangements.

FIG. 13a shows the mechanism in a first configuration, when both pneumatic actuators 21 and 22 are extended. In this configuration claw 16 and retention member 17 are retracted from chute 10 (see FIG. 12a) and do not obstruct the upper road cone holding section of chute 10 so that road cones may move up or down in the chute.

FIG. 13b shows a second configuration, in which pneumatic actuator 21 is extended and pneumatic actuator 22 is retracted, in which retention member 17 obstructs chute 10 so as to support any road cones in the upper road cone holding section (see FIG. 12b).

FIG. 13c shows a third configuration, when both pneumatic actuators 21 and 22 are retracted, in which claw 16 has rotated to a position between adjacent road cones in the upper road cone holding section of chute 10 to separate adjacent road cones as it rotates and then retain the upper road cone and release the lower road cone (see FIG. 12c).

In use, when deploying road cones, a stack of road cones 4 is delivered to chute 10 which is supported by deployment mechanisms 14 and 15 as shown in FIG. 12b. In its deployment mode the deployment mechanisms 14 and 15 move between the configurations shown in FIGS. 13b and 13c. The deployment mechanisms 14 and 15 are initially in the configuration shown in FIG. 13b (see FIG. 12b) so that the stack of road cones 4 is supported by retention members 17. To deploy the next road cone in the stack pneumatic cylinder 21 is retracted, causing claw 16 to rotate between the bases of adjacent road cones in the stack (the bottom road cone and next road cone up). As the claw is in the form of an element of varying radial dimension it separates adjacent road cones as the radial dimension between adjacent road cones increases. “Varying radial dimension” is used to describe a form that has a different dimension from side to side for different rotational positions. In particular forms that continuously increase their lateral dimension as rotated. It will be appreciated that a claw need not be employed and that other shapes of varying radial dimension may be used and different motions may be employed. For example wedges could be driven inwardly along a linear path to effect road cone separation.

When the claw 16 has fully rotated to the position shown in FIG. 13c (see FIG. 12c) the bottom road cone will be released and the stack of road cones above will be held by the upper surface of claws 16. The road cone will drop down through the chute 10 to be deployed on the road below and pass through rear opening 11 of chute 10. Pneumatic ram 21 will then be extended so that the retention members 17 are deployed to support the stack of road cones for the next road cone deployment. Once a full stack of road cones has been deployed the conveyor system can deliver a new stack of road cones 4 to chute 10 as described above. A bar 13 (See FIG. 3) may be deployed at an angle to vehicle 1 at a height suitable to guide road cones released from road cone deployment and collection unit 7 outwardly from the side of the truck where it is desired to deploy cones further away from vehicle 1. Bar 13 projects outwardly and rearwardly and is positioned so as to guide a road cone outwardly from the vehicle as it moves forward.

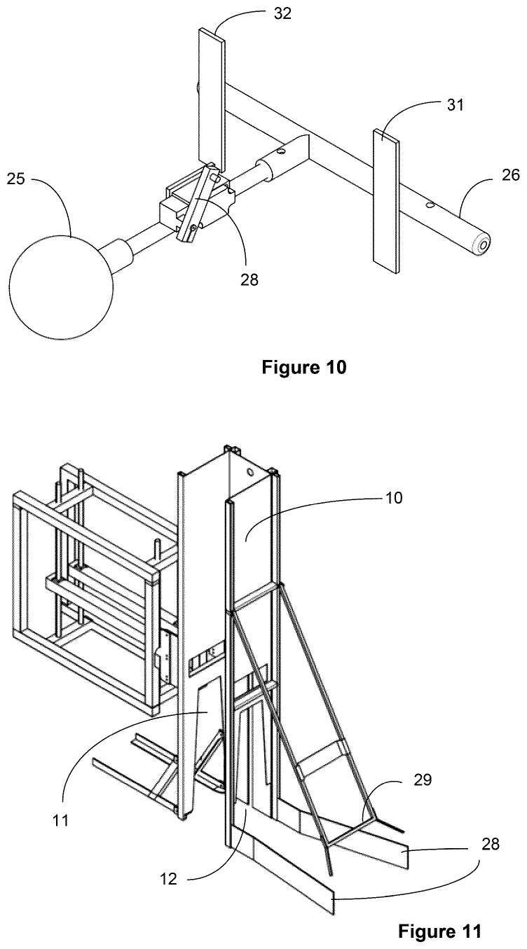

Referring to FIGS. 10 and 11 features of road cone deployment and collection unit 7 for cone collection will be described. A lance 25 is mounted to a rotatable shaft 26 that may be rotated by actuator 27 between a horizontal and vertical position. A sensor 28 detects when a road cone is engaged on lance 25 to initiate rotation from a horizontal to a vertical position. Once a cone is rotated to a vertical position the whole lance assembly may be raised so that a recovered cone may be stacked in chute 10. When not in use, during cone deployment, the whole lance assembly may be moved out of the chute 10 or above a stack of cones.

As shown in FIG. 11 guides 28 extend from the front of chute 10 to guide a road cone to be collected into opening 12. A knock down bar 29 causes a road cone to be knocked flat during collection so that it may be captured by lance 25.

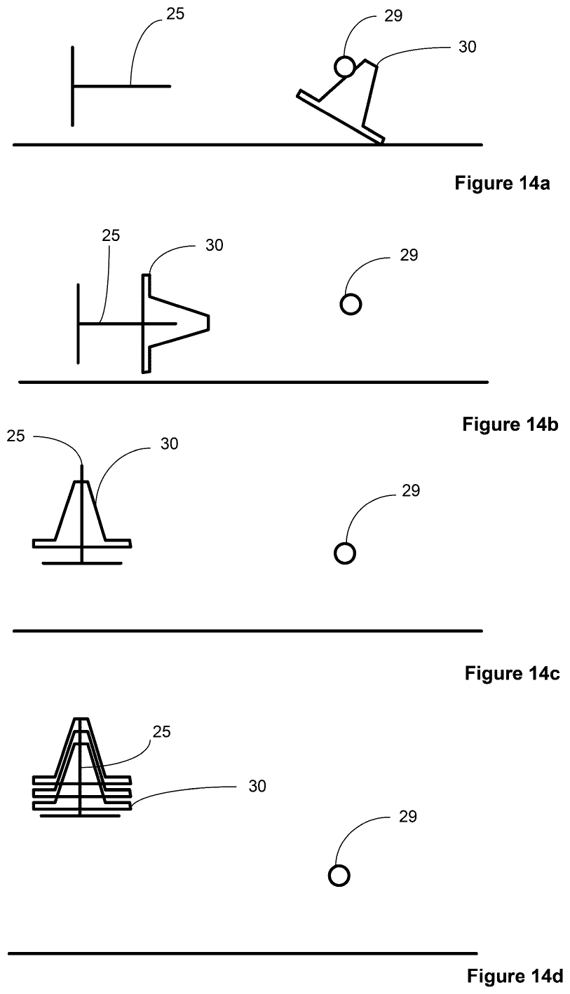

Referring now to the schematic drawings of FIGS. 14a to 14d a method of collecting road cones using the road cone deployment and collection system will be described. During road cone collection lance 25 is lowered and rotated to a horizontal position as shown in FIG. 14a. As the truck is driven towards a road cone 30 it may be brought into alignment with the front opening 12 of chute 10 by guides 28 and a knock down device 29 may knock the road cone 30 over so that it lies flat as shown in FIG. 14b. The knock down device 29 may be a bar or chain etc. As the truck advances road cone 30 enters the front opening 12 and lance 25 engages road cone 30 through its base.

When sensor 28 detects that road cone 30 is engaged an actuator 27 rotates lance 25 to a vertical position as shown in FIG. 14c. Lance 25 and road cone 30 are then lifted up through chute 10 as shown in FIG. 14d. As lance 25 approaches mechanisms 14 and 15 they adopt the configuration shown in FIG. 13a so that a stack of road cones 4 in the chute 10 fall and are supported by lance 25 and base plates 31 and 32 and once the stack of road cones is lifted above mechanisms 14 and 15 they adopt the configuration shown in FIG. 13b so that retention members 17 hold the stack of road cones 4 in the chute 10. Lance 25 may then be lowered to collect the next road cone.

When a sensor detects that a stack of road cones in the chute 10 has reached a prescribed height the stack may be pushed out of chute 10 by a pusher so that a new stack may be collected in the chute. Lance 25 may be moved out of the way during road cone deployment.

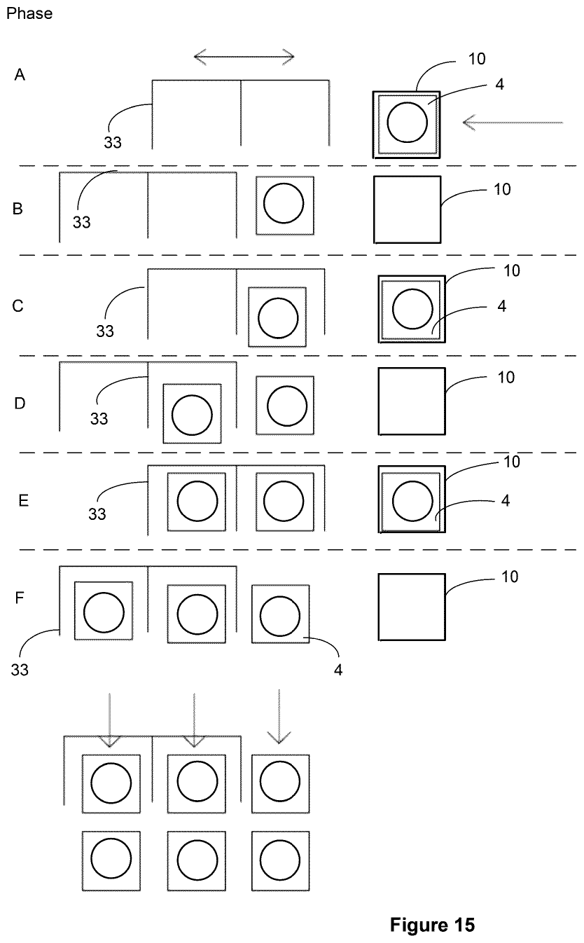

FIG. 15 illustrates how stacks of cones from chute 10 may be loaded onto the truck. Each phase A to F illustrates how the front row of cones is loaded in sequence. In phase A a complete stack of cones moves to the left out of the chute 10 with pusher 33 also moving to the left to the position shown in phase B. Pusher 33 is then retracted and moved to the right to the position shown in phase C. When the next full stack of cones is assembled in phase C it moves to the left out of the chute 10 with pusher 33 also moving to the left to the position shown in phase D. Pusher 33 is then retracted and moved to the right as shown in phase E. When the next full stack of cones is assembled in phase E it moves to the left out of the chute with pusher 33 also moving to the left to the position shown in phase F, in which position the complete row of stacks of cones is pushed back along respective guide rails ready for a new row to be loaded.

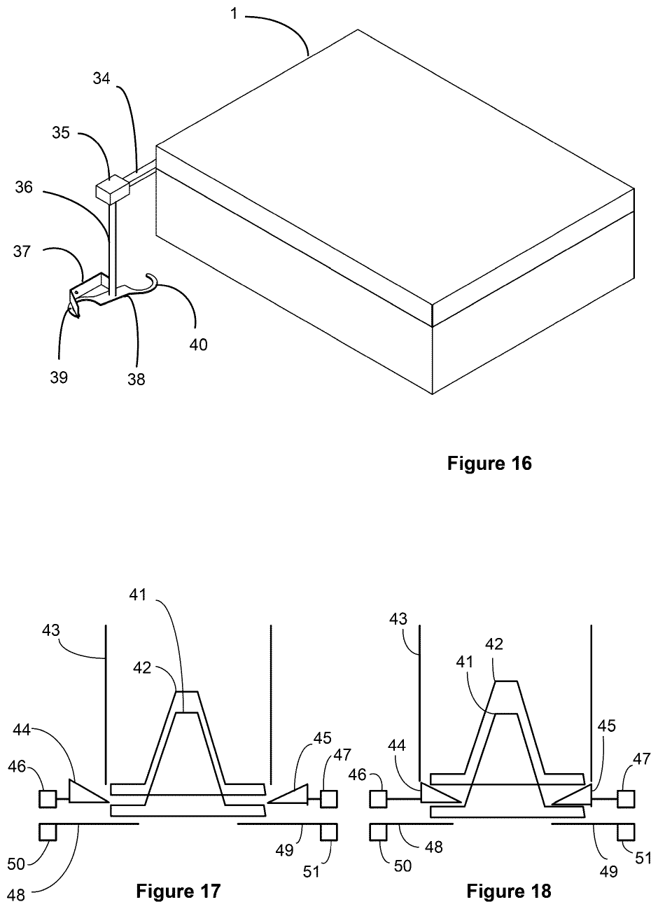

FIG. 16 shows a spinner system that may be deployed on a vehicle 1 with the road cone deployment and collection system described above. A motor 35 of the spinner system may be mounted to vehicle 1 by strut 34 in a permanent, removable or extendable fashion. Shaft 36 supports spinner 38 which is rotated when driven by motor 35 via a drive shaft within shaft 36. Spinner 38 has a first hook 39 on one side and a second hook 40 on the other side. A sensor bar 37 detects a cone and causes motor 35 to rotate spinner 38 by 180 degrees.

In use the spinner is aligned with the position where cones will be deployed or guide bars are used to guide a cone into a hook (in FIG. 16 hook 39). When the cone is detected by sensor bar 37 spinner 38 rotates 180 degrees so that the cone is moved to the position of hook 40 and exits to the back. This enables the cone to be translated by a fixed distance inwards (or outwards if configured with hooks in the opposite direction and sensor bar in the inward side).

FIGS. 17 and 18 illustrate a road cone deployment and collection mechanism employing a wedge design. In FIG. 17 road cones 41 and 42 are stacked upon each other within a chute 43. Wedges 44 and 45 are driven by respective actuators 46 and 47, such as pneumatic rams, which can drive wedges 44 and 45 inwardly or outwardly. Retention elements 48 and 49 support the road cones and actuators 50 and 51, such as pneumatic rams, which can drive retention elements 48 and 49 inwardly or outwardly.

When road cone 41 is to be released wedges 44 and 45 may be driven inwardly by actuators 46 and 47 to the position shown in FIG. 18 to separate the road cones. Retention elements 48 and 49 may then be withdrawn outwardly by actuators 50 and 51 to allow road cone 41 to be dropped and deployed. Retention elements 48 and 49 may then be extended and wedges 44 and 45 retracted to the configuration shown in FIG. 18 for the next cycle. During road cone collection retention elements 48 and 49 and wedges 44 and 45 may all be retracted to allow a road cone to be added to the stack from below as per the previous embodiment.

The road cone deployment and collection system thus allows road cone deployment and collection from a single system without requiring reconfiguration. The system is also capable of simultaneous collection and re-deployment allowing a line of road cones to be redeployed at different intervals and/or in different positions.

Control of the actuators and other automated components may be effected by a suitable controller such as a PLC using sensor signals and/or programmed sequences as will be well understood by those in the field.

There is thus provided a road cone deployment and collection system that is fully automated, requiring only a driver of a vehicle to deploy and recover road cones, removing people from hazardous working situations. The system includes a road cone deployment mechanism that ensures effective separation of road cones. A universal configuration may be employed allowing deployment and collection without requiring reconfiguration. Road cones may be collected when the vehicle is driving forward. Road cone deployment and collection chutes may be provided on one or both sides. The system is modular and functionality can be added as required or the system can be easily reconfigured. The system is simple and cost effective and removes people from hazards on the road.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A road cone deployment and collection system comprising:
a chute having an upper road cone holding section, a rear opening at the bottom of the chute for road cone deployment and a front opening at the bottom of the chute for road cone collection; and
a road cone retention and release mechanism configured to:
hold a stack of road cones;
separate and release one road cone at a time from the stack to the chute for deployment from the rear opening; and
add a road cone to a stack of road cones collected from the front opening of the chute and raised to be added to a stack of road cones.

2. A road cone deployment and collection system as claimed in claim 1 wherein the road cone retention and release mechanism includes one or more element of varying radial dimension configured to be positioned between the bases of adjacent road cones and rotated to separate adjacent road cones.

3. A road cone deployment and collection system as claimed in claim 1 wherein the road cone retention and release mechanism includes one or more retention member to support one or more road cones in the upper road cone holding section or release one or more road cone.

4. A road cone deployment and collection system as claimed in claim 2 wherein the element of varying radial dimension is in the form of a claw.

5. A road cone deployment and collection system as claimed in claim 4 wherein the claw has a hook and the hook is configured to engage the base of a lower road cone of a pair of stacked road cones whilst the body of the claw engages the base of an upper road upper road cone of the pair of stacked road cones.

6. A road cone deployment and collection system as claimed in claim 5 wherein each claw is rotated by an actuator.

7. A road cone deployment and collection system as claimed in claim 6 wherein the retention member rotates with the claw.

8. A road cone deployment and collection system as claimed in claim 7 wherein the claw and retention member are configured to move between:
a first configuration in which each claw and retention member do not obstruct the upper road cone holding section;
a second configuration in which each retention member supports any road cones in the upper road cone holding section; and
a third configuration in which each claw has rotated to a position between adjacent road cones in the upper road cone holding section to retain the upper road cone and release the lower road cone.

9. A road cone deployment and collection system as claimed in claim 1 wherein the road cone retention and release mechanism includes one or more retention member to support one or more road cones in the upper road cone holding section or release one or more road cone and one or more road cone separator.

10. A road cone deployment and collection system as claimed in claim 9 wherein the retention member is separate from the road cone separator.

11. A road cone deployment and collection system as claimed in claim 9 wherein the road cone separator includes one or more wedge configured to be driven between adjacent road cones to separate them.

12. A road cone deployment and collection system as claimed in claim 9 wherein the road cone separator includes one or more pairs of road cone engaging elements configured to separate between adjacent road cones to separate them.

13. A road cone deployment and collection system as claimed in claim 1 including a guide that centralises road cones entering the front opening of the chute.

14. A road cone deployment and collection system as claimed in claim 1 including a road cone knock down device to rotate any standing road cone entering the front opening of the chute to a lie down position.

15. A road cone deployment and collection system as claimed in claim 14 including a lance configured to engage the base of a road cone entering the front opening of the chute.

16. A road cone deployment and collection system as claimed in claim 15 wherein the lance is configured to rotate from a lowered to an upright position when a road cone is engaged and lift an acquired road cone to the upper road cone holding section.

17. A road cone deployment and collection system as claimed in claim 1 having road cone storage area to supply stacks of road cones to the chute or receive stacks of road cones from the chute.

18. A road cone deployment and collection system as claimed in claim 1 including a rotating arm positioned to capture road cones exiting from the rear opening at the bottom of the chute to laterally shift each road cone.

19. A road cone deployment and collection system as claimed in claim 1 including a guide positioned to guide road cones exiting from the rear opening at the bottom of the chute to laterally shift each road cone.

20. A road cone deployment mechanism for selectively releasing a road cone from a stack of road cones including a road cone separation mechanism configured to separate the bases of adjacent road cones from each other.

21. A road cone deployment mechanism as claimed in claim 20 in the form of a wedge configured to be driven between the bases of a pair of stacked road cones to separate the bases.

22. A road cone deployment mechanism as claimed in claim 21 wherein the wedge is driven by a linear actuator.

23. A road cone deployment mechanism as claimed in claim 1 including a translation mechanism configured to translate the road cone deployment system between a first configuration for transport and a second configuration for deployment wherein the road cone deployment system is extended outwardly from the vehicle in the second configuration.

24. A road cone deployment mechanism as claimed in claim 1 including a spinner for moving a road cone laterally with respect to a path of movement of the vehicle.

25. A road cone deployment mechanism as claimed in claim 24 wherein the spinner includes a hook to capture a road cone and is rotatable to laterally translate a road cone captured by the hook.

26. A road cone retention and release mechanism including a claw and retention member configured to move into a chute between:
a first configuration in which each claw and retention member do not obstruct the chute;
a second configuration in which each retention member supports any road cones in the chute; and
a third configuration in which each claw is rotated to a position between any adjacent road cones in the chute to retain the upper road cone and release the lower road cone.
